(19) United States
(12) Patent Application Publication
(10) Pub. No.: US 2026/0066147 A1
(43) Pub. Date: Mar. 5, 2026

(54) DRY ENVIRONMENT SPENT NUCLEAR FUEL CANISTER LID CUTTING SYSTEM

(71) Applicant: KOREA RADIOACTIVE WASTE AGENCY, Gyeongju-si (KR)

(72) Inventors: Jeong Hwan LEE, Daejeon (KR); Min Seok KIM, Daejeon (KR); Chang Min SHIN, Daejeon (KR); Hyung Joo YOON, Daejeon (KR); Man Ho HAN, Daejeon (KR); Seo Yeon CHO, Daejeon (KR); Tae Chul MOON, Daejeon (KR); Hyun Goo KANG, Daejeon (KR); Sang Hwan LEE, Daejeon (KR)

(21) Appl. No.: 19/260,190

(22) Filed: Jul. 3, 2025

(30) Foreign Application Priority Data
Aug. 27, 2024 (KR) 10-2024-0115249

(51) Int. Cl. G21F 5/14; G21F 5/12

(52) U.S. Cl. CPC G21F 5/14; G21F 5/12

(57) ABSTRACT

Provided is a spent nuclear fuel canister lid cutting system in dry environment which enables to safely transport the canister to which spent nuclear fuel is enclosed; to smoothly and easily lift and take out the canister to the cutting work space; to prevent the cutting work space from being exposed to radiation materials while cutting the canister lid; and to prevent a cover of a handling cask, which stores the canister, from being exposed to radiation materials. Thus, this system quickly and safely performs all working operations in order for superior work efficiency and high safety.

### TECHNICAL FIELD

This work was supported by the Korea Institute of Energy Technology Evaluation and Planning(KETEP) and the Ministry of Trade, Industry & Energy(MOTIE) of the Republic of Korea (No. RS-2021-KP002663).

The present invention relates to a spent nuclear fuel canister lid cutting system in dry environment and, more specifically, to a spent nuclear fuel canister lid cutting system in dry environment which enables to safely transfer the canister to which spent nuclear fuel is enclosed; to smoothly and easily lift and take out the canister to the cutting work space; to prevent radiation materials from being released outside the cutting work space while cutting the canister lid; and to prevent a handling cask cover from being exposed to radiation materials.

### BACKGROUND ART

For final disposal, generated PWR spent nuclear fuel is sealed in a spent nuclear fuel canister and is stored in an interim storage facility for a long period.

It is required to repackage a disposal canister under a sealed hot cell in a repackaging facility at disposal sites for final disposal of spent nuclear fuel.

The spent nuclear fuel canister is in a state of a seal weld. For withdrawing stacked spent nuclear fuel, it is required to cut off a welded lid in a sealed hot cell. These operations are performed in high temperature and high radiation areas and thus, every operations need to be performed in detailed remotely by limiting workers'access.

It is required to obtain a means of effectively lifting up and transporting a cut-off lid for preventing cut-off lid from detaching toward an unexpected spot after cutting off the lid of the canister. Also, a means of cutting of the lid of the canister easily is needed.

The way of lifting up spent nuclear fuel canister in combination of an adaptor by means of thread grooves, etc., in the cover has been generally used.

Accordingly, in a repackaging facility, the cover is cutting off in order to extract spent nuclear fuel from the canister and then, there is a problem of having difficulty in lifting up the canister.

Meanwhile, cutting off the lid of the canister is mainly performed in a wet storage in America, etc., abroad. However, there have been no specific examples. In Finland or Sweden, repackaging is performed in dry environment, but they use a non-canister type, e.g. a bare fuel type cask. Thus, they have different conditions as compared to ours.

As above, as for spent fuel handling devices, Korean Patent Registration no. 10-0905379 discloses spent fuel handling devices and encapsulation process system having the same wherein there have been high efficiency, accuracy and safety in a hot cell of a repackaging facility.

Further, Korean Patent Registration no. 10-2305376 discloses systems and methods for transferring spent nuclear fuel from wet storage to dry storage.

Further, Korean Patent Registration no. 10-2269339 discloses a cutting equipment for CANDU spent fuel basket and Korean Patent Registration no. 10-2351442 discloses a cutting equipment for spent fuel basket loaded spent nuclear fuel.

Further, Korean Patent Registration no. 10-2495456 discloses a multi-component cask for storage and transport of spent nuclear fuel.

However, the above cited patent registrations have no technical constitution for delivering, lifting, transporting, taking out and cutting the canister lid, sealed by molding, in high temperature and high radioactive environment for repackaging of spent nuclear fuel.

### Prior Art

(Patent document 001) Korean Patent Registration No. 10-0905379
(Patent document 002) Korean Patent Registration No. 10-2305376
(Patent document 003) Korean Patent Registration No. 10-2269339
(Patent document 004) Korean Patent Registration No. 10-2351442
(Patent document 005) Korean Patent Registration No.10-2495456

### DISCLOSURE

### Technical Problem

For solving above problems, the object of the present invention is to provide a spent nuclear fuel canister lid cutting system in dry environment which enables to safely transport the canister to which spent nuclear fuel is enclosed; to smoothly and easily lift and take out the canister to the cutting work space; to prevent the cutting work space from being exposed to radiation materials while cutting the canister lid; and to prevent a cover of a handling cask, which stores the canister, from being exposed to radiation materials.

Further, the another object of the present invention is to lift and take out the canister lift can with more stable conditions.

Further, the another object of the present invention is to prevent chips generated while cutting the canister lid from falling into the storage space.

Further, the another object of the present invention is to safely and smoothly transport the canister whose lid has been cut.

### Technical Solution

To accomplish above objects, a spent nuclear fuel canister lid cutting system in dry environment comprises a transfer trolley for transporting a canister lift can for comprising a canister with sealed spent nuclear fuel, and a handling cask on which a lid is covered with the inserted canister lift can; a cutting work space; a docking hole is formed on the bottom side to be docked with the disposal canister; and a cutting work space keeps leak tightness while maintaining negative pressure for preventing release of radioactive materials; an opening-closing apparatus which enables to open and close the docking hole at the bottom side of the cutting work space by moving on a rail while storing the handling cask cover; a lifting apparatus which enables to lift and transport using a crane which is installed on the top of the cutting work space; a canister cutting station which stores the canister lift can which is lifted and transported from the docking hole, thereby cutting the canister lid; and a canister lid transport apparatus which combines to the canister lid on one side of the cutting work space, thereby supporting while cutting, and taking out after cutting.

Hereinafter, the transfer trolley is equipped with a rotation bed for rotating the canister lift can.

Hereinafter, the opening-closing apparatus comprises a shielding plate body for closing and opening the docking hole and storing the cover of the handling cask while being sliding along a rail by driving means, and an opening-closing lid for storing or taking out the handling cask cover, which is operated by driving means to prevent contamination against radioactive materials at one side of the shielding plate body.

Hereinafter, a plurality of support protrusions is formed for holding the cover of the handling cask, installed to the bottom side of the shielding plate body.

Hereinafter, the lifting apparatus comprises a lifting body forming a plurality of lifting legs to which a rope of the transport crane is connected on the top; a lifting gripper connecting to a joining groove formed on the top of the cover of the handling cask while being moving up and down by a driving means such as a geared motor, gear mesh, etc., in the center of the lifting body; and a plurality of locking hooks engaging with a plurality of locking grooves formed on the top of the canister lift can around the bottom side of the lifting body.

Hereinafter, the canister cutting station comprises a storage block forming a storage space wherein the canister lift can is stored to the bottom side of the cutting work space; each slide board half-divided to keep moving right and left on a rail, formed on both sides of the top of the storage block, by driving means; and a clamshell cutting apparatus having cutting devices on the top of each slide board.

Hereinafter, the bottom side of the storage space should comprise the rotation bed for rotating the canister lift can and each camera on the top and bottom of the storage space for checking whether the canister lift can is seated correctly.

Hereinafter, the canister lid transport apparatus comprises a transport bracket member for moving along the rail between the canister cutting station and the docking hole, formed on one side of cutting work space, by driving means; and a canister lid combination member for having each bolt that may connect to holes for each bolt in the canister lid part, while being lifted by a driving means on the end of the transport bracket member.

Hereinafter, each bolt installed to the canister lid combination member is rotated by a driving means inside the canister lid combination member.

### Advantageous Effects

The present invention enables to safely transport the canister to which spent nuclear fuel is enclosed; to smoothly and easily lift and take out the canister to the cutting work space; to prevent the cutting work space from being exposed to radiation materials while cutting the canister lid; and to prevent a cover of a handling cask, which stores the canister, from being exposed to radiation materials, thereby quickly and safely perform all working operations in order for superior work efficiency and high safety.

Further, upon lifting and taking out the canister lift can, it may obtain high safety with more stable conditions.

Further, high reliability of cutting operation has been established by preventing chips generated while cutting the canister lid from falling into the storage space.

Further, the canister, whose lid has been cut, may be safely and smoothly transported, thereby enhancing work efficiency.

### DESCRIPTION OF DRAWINGS

FIG. 1 illustrates a partial cutting perspective view for explaining the present invention.

FIG. 2 illustrates a partial cutting perspective view for explaining a canister, a canister lift can and a disposal canister.

FIG. 3 illustrates a core extracting perspective view for explaining an opening-closing apparatus of the present invention.

FIG. 4 illustrates a core extracting perspective view for explaining a lifting apparatus of the present invention.

FIG. 5 illustrates a core extracting perspective view for explaining storage block and canister cutting station of the present invention.

FIG. 6 illustrates a core perspective view for explaining a canister lid transport apparatus of the present invention.

FIG. 7 illustrates a flow chart for explaining operation processes of the present invention.

### DESCRIPTION OF THE PREFERRED EMBODIMENTS

The configuration of a spent nuclear fuel canister lid cutting system in dry environment of the present invention will be described in detail with the accompanying drawings.

In the following description of the present invention, a detailed description of known incorporated functions and configurations will be omitted when to include them would make the subject matter of the present invention rather unclear. Also, the terms used in the following description are defined taking into consideration the functions provided in the present invention. The definitions of these terms should be determined based on the whole content of this specification, because they may be changed in accordance with the option of a user or operator or a usual practice.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

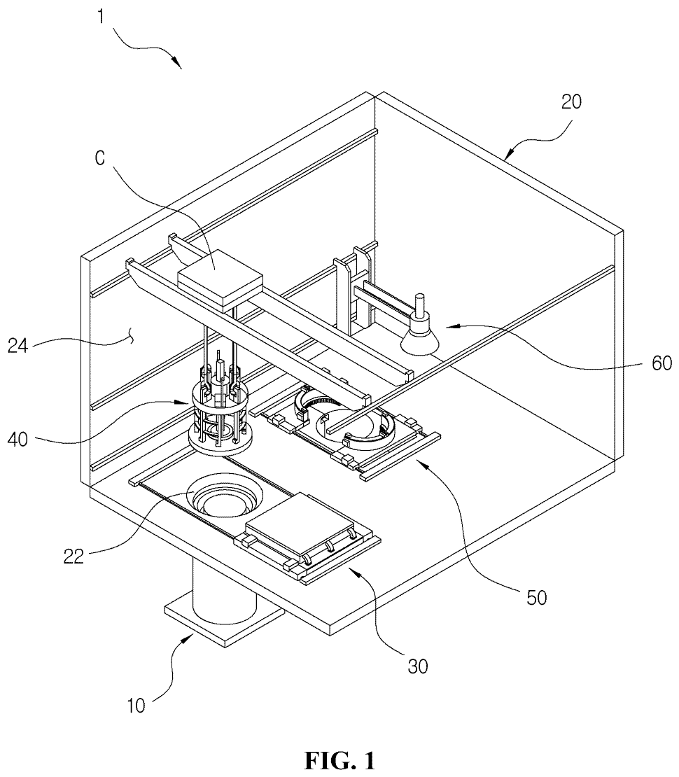

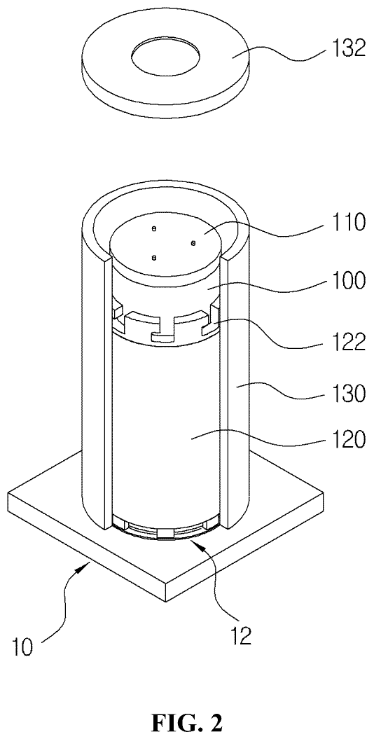

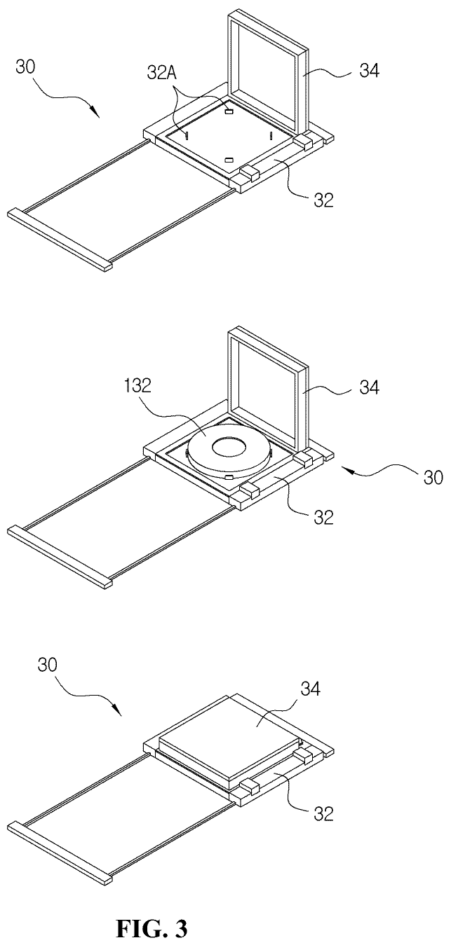

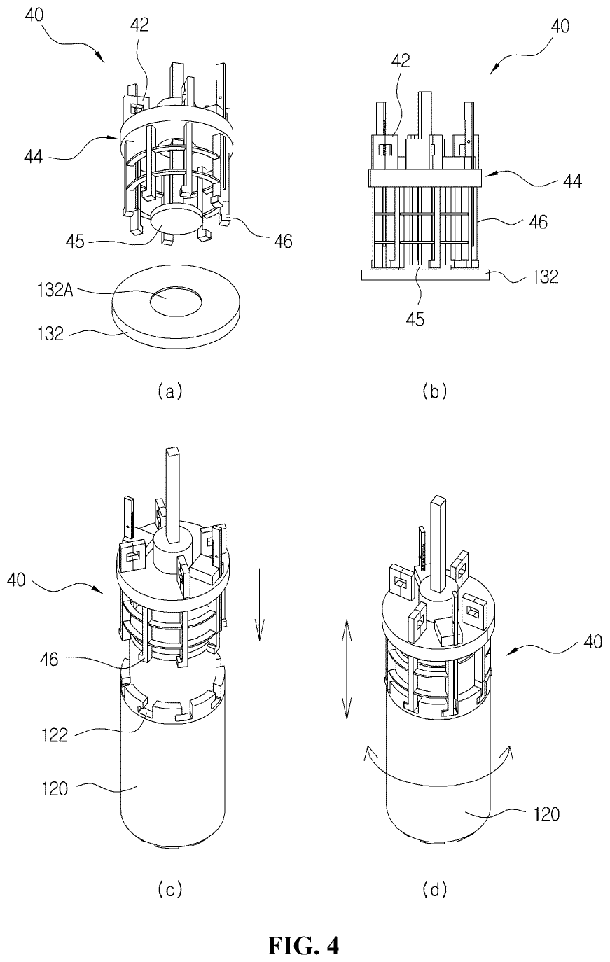

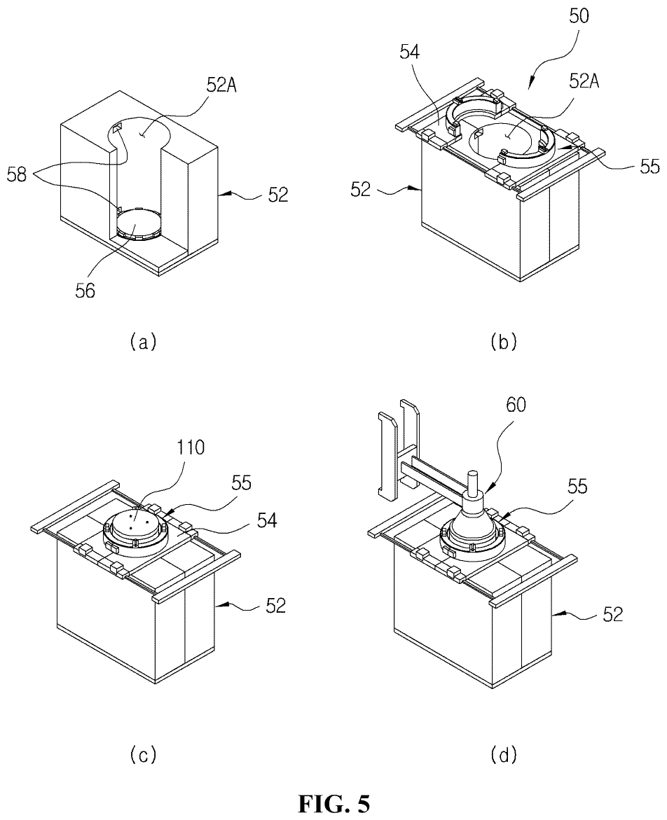

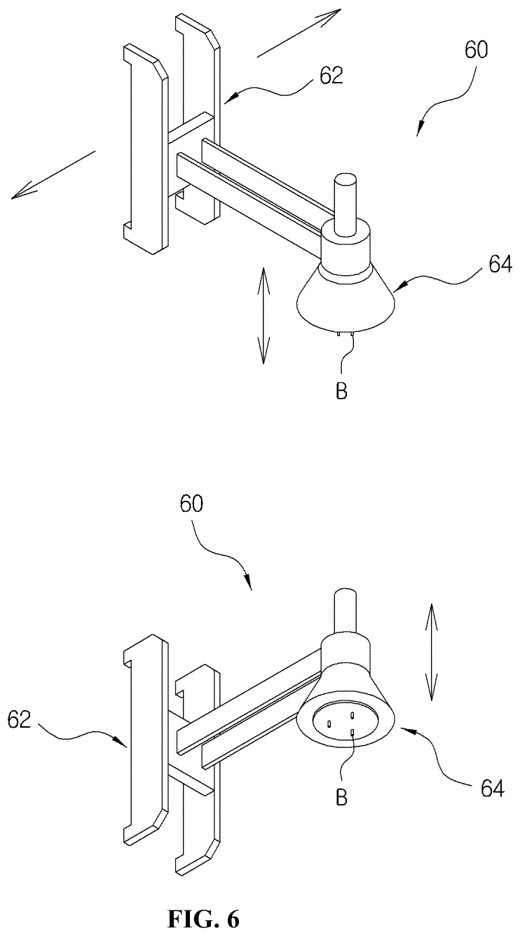

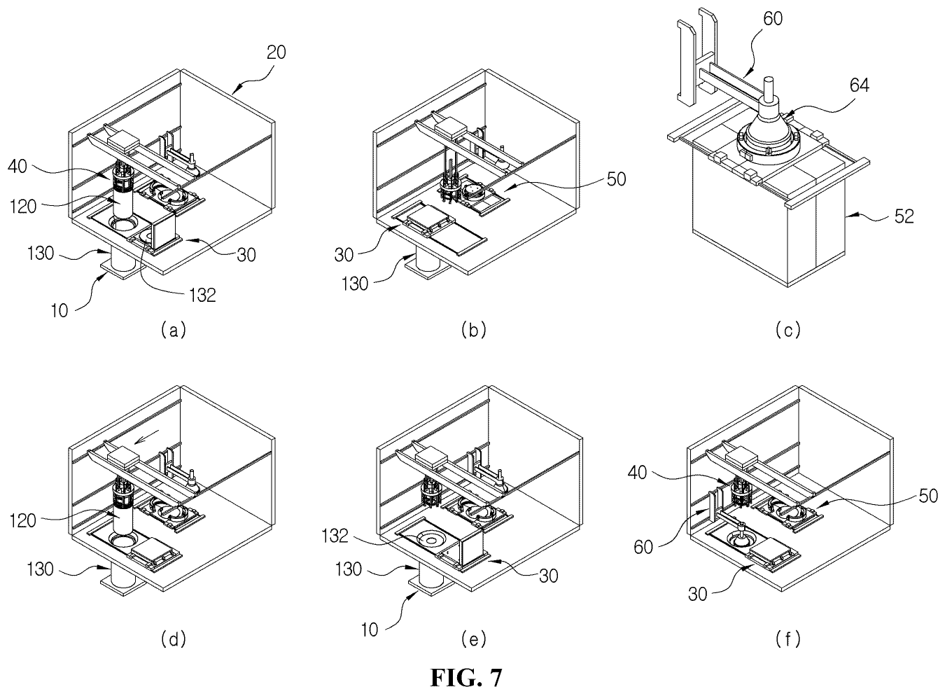

FIG. 1 illustrates a partial cutting perspective view for explaining the present invention; FIG. 2 illustrates a partial cutting perspective view for explaining a canister, a canister lift can and a disposal canister; FIG. 3 illustrates a core extracting perspective view for explaining an opening-closing apparatus of the present invention; FIG. 4 illustrates a core extracting perspective view for explaining a lifting apparatus of the present invention; FIG. 5 illustrates a core extracting perspective view for explaining storage block and canister cutting station of the present invention; FIG. 6 illustrates a core perspective view for explaining a canister lid transport apparatus of the present invention; and FIG. 7 illustrates a flow chart for explaining operation processes of the present invention.

As illustrated, a spent nuclear fuel canister is in a state of seal welding as described in the background art and thus, cutting a welded lid in a sealed hot cell for taking out spent nuclear fuel, stacked therein, is required. A plurality of holes, which connect bolts, for lift is formed in the canister lid, thereby being lifted by a lift adapter, etc.

However, the cited patent applications do not have technical constitutional elements for cutting the canister lid.

The present invention provides a spent nuclear fuel canister lid cutting system enabling to safely transfer the canister in which the spent nuclear fuel is sealed; to be smoothly and easily lifting and releasing to a cutting work space; to prevent radioactive materials from releasing outside as for a work space for cutting the canister lid when performing a canister lid cutting operation; and to prevent a cover of the handling cask, in which the canister is stored, from being contaminated by radioactive materials.

A spent nuclear fuel canister lid cutting system(1) according to the present invention consists of specific technical constitutions such as a transfer trolley(10), a cutting facility(20), an opening-closing apparatus(30), a lifting apparatus(40), a canister cutting station(50) and a canister lid transport apparatus(60).

Transferring a canister(100) to a cutting facility(20) such a hot cell for cutting a lid(110), the transfer trolley(10) has a technical constitution of transporting a canister lift can(120) for comprising a canister(100) with sealed spent nuclear fuel, and a handling cask(130) for covering a handling cask cover(132) with the inserted canister lift can(120).

In other words, the transfer trolley is moved on plural wheels or rails, which are rolling means for moving at the bottom, by a motor, etc., not illustrated. The transfer trolley is generally formed in a plate, etc., and the handling cask is put on the top while moving.

Further, it is desirable that the transfer trolley(10) is equipped with a turntable-shaped rotation bed(12) for rotating the canister lift can(120). The rotation bed is rotated by a motor, as a driving means, and gear mesh on a fixed bed. Upon lifting the canister lift can by a lifting apparatus, a hanging loop of the lifting apparatus is inserted to a hole, formed on the top of the canister lift can, thereby enabling to be easily lifted by rotating the canister lift can and closely inserting the hanging loop to the hole.

Cutting the canister lid, the cutting facility(20) has a condition as same with the hot cell. For cutting the lid of the canister, the handling cask(130) at one side of the bottom is moved by the transfer trolley(10); a docking hole(22) is formed to be docked with the handling cask(130); and a cutting work space(244) keeps leak tightness while maintaining negative pressure for preventing release of radioactive materials.

In other words, the canister cutting facility enables to transfer the canister to the cutting work space; to cut the lid of the canister; and to prevent release of radioactive materials during cutting the lid of the canister.

Thus, the docking hole is open by an opening-closing means and closed for keeping leak tightness.

Opening and closing the docking hole(22) at the bottom surface wherein the docking hole(22) of the cutting work space(24) is formed, the opening-closing apparatus(30) enables to be sliding along a rail for storing the handling cask cover(132).

The specific technical constitutions of the opening-closing apparatus(30) comprise a shielding plate body(32) for closing and opening the docking hole(22) and storing the handling cask cover(132) while being sliding along a rail by driving means such as a rack-pinion gear type, transfer screw, a nut housing method, etc., not illustrated, and an opening-closing lid(34) for opening and closing the handling cask cover(132), which is installed by driving means such as gear mesh, a link mode, etc., to prevent contamination against radioactive materials at one side of the shielding plate body(32). It is desirable to form a plurality of support protrusions(32A) for preventing flexibility by supporting the external side of the handling cask cover(132), installed to the bottom side of the shielding plate body(32).

In other words, the opening-closing apparatus is open when lifting and releasing the canister lift can, and is closed when cutting the canister lid, thereby enabling to keep leak tightness and prevent radioactive materials from leaking out.

Further, the opening-closing apparatus stores the cover of the handling cask and thus, the opening-closing lid is closed when cutting the canister lid, thereby preventing the lid of the disposal canister, stored from radioactive material, from being contaminated.

The lifting apparatus(40) lifts, transfers and takes the canister lift can(120) out of the transfer trolley(10) through the docking hole(22). Going up and down by a transport crane(C), which is configured to move in every directions on the top of the cutting work space(24), the lifting apparatus(40) enables to lift, transfer and take out the canister lift can(120).

The lifting apparatus(40) comprises a lifting body(44) forming a plurality of lifting legs(42) to which a rope of the transport crane(C) is connected on the top; a lifting gripper(45) connecting to a joining groove(132A) formed on the top of the handling cask cover(132) while being shuttled by a driving means such as a geared motor, gear mesh, etc., in the center of the lifting body(44); and a plurality of locking hooks(46) engaging with a plurality of locking grooves(122) formed on the top of the canister lift can(120) around the bottom side of the lifting body(44). The locking grooves and the locking hooks are corresponded each other, in half-turn shape of a capital letter “L”.

In other words, the lifting apparatus(40) in the docking hole lifts the cover of the handling cask by using the lifting gripper and puts to the shielding plate body as an opening-closing apparatus. Then, a plurality of locking hooks is inserted into a plurality of locking grooves formed on the top of the canister lift can through the docking hole. Then, the locking hooks are closely locked to the locking grooves by rotation of the rotation bed equipped with the transfer trolley.

The locking hooks engage with the locking grooves, thereby taking to the cutting work space by the transport crane and transferring to the cutting work space for cutting the canister lid.

The canister cutting station(50) stores the canister lift can(120) which is lifted and transferred from the docking hole(22), thereby cutting the canister lid(110).

The detailed technical constitution of the canister cutting station(50) comprises a storage block(52) forming a storage space(52A) wherein the canister lift can(120) is stored to the bottom side of the cutting work space(24); each slide board(54) half-divided to be shuttled right and left on a rail, formed on both sides of the top of the storage block(52), by driving means such as a rack-pinion gear type, transfer screw, a nut housing method, etc., not illustrated; and a clamshell cutting apparatus(55) having cutting devices on the top of each slide board(54). Also, the clamshell cutting apparatus is half-divided same as each slide board.

Upon searching “clamshell cutting” in YouTube or Google, etc., the clamshell cutting apparatus applies to the device which is uploaded to videos in the website below, and has same technical constitution of general circular pipe cutting devices. Accordingly, the detailed technical constitution and the detailed operations of the clamshell cutting apparatus are omitted.

Https://youtu.be/9voGBcSrJM4?si=aZBe-r3H602dpdM

In other words, the canister lift can is inserted to the storage space of the storage block by the lifting apparatus, thereby moving each slide board smoothly and closely facing to the external side of the canister.

Then, the canister lid transport apparatus(60) is connected to the canister lid(110).

Then, the cutting devices of the clamshell cutting apparatus are rotated to cut the canister lid. At this time, chips generated while cutting fall onto the top of each slide board, not into the storage space.

If the cutting operation of the canister lid is finished, each slide board is split again simultaneously with stopping the operation of the clamshell cutting apparatus. As the canister lid, cut by the canister lid transport apparatus, is also transported, the canister lift can may be lifted by the lifting apparatus.

Furthermore, it is desirable that the bottom side of the storage space(52A) should comprise the rotation bed(56) for rotating the canister lift can(120) and each camera on the top and bottom of the storage space for checking whether the canister lift can (120) is seated correctly.

The technical constitution of the rotation bed is the same as that of the transfer trolley. While the canister lift can is inserted to the storage space by the lifting apparatus, the locking hooks are rotated for being separated from the locking grooves of the canister lift can and, upon lift, are rotated again for inserting the locking hooks into the locking grooves.

Furthermore, each camera checks whether or not to correctly place the canister lift can, inserted to the storage space, onto the rotation bed.

The canister lid transport apparatus(60) has the technical constitution wherein the canister lid(110) is combined to the canister lid transport apparatus(60) attached to one side of the cutting work space(24), thereby lifting the canister lid, which has been cut, and taking out to the outside of the cutting work space.

The detailed technical constitution of the canister lid transport apparatus(60) comprises a transport bracket member(62) for being moving along a rail between the canister cutting station(50) and the docking hole(22) on a rail, formed on one side of cutting work space(24), by driving means such as a rack-pinion gear type, transfer screw, a nut housing method, etc., not illustrated; and a canister lid combination member(64) for having each bolt(B) connected to each hole, which connects bolts, while being lifted by a driving means such as a geared motor, gear mesh, etc., on the end of the transport bracket member(62).

Each bolt(B) installed to the canister lid combination member(64) is rotated by a driving means inside the canister lid combination member(64), i.e., a driving means such as a satellite gear rotated by a motor equipped with each bolt or one motor.

In other words, in the canister lid transport apparatus, upon cutting the canister lid using the canister cutting station, the canister lid is connected to the canister lid combination member for lifting, and when cutting action is finished, the canister lid combination member goes up and down.

Then, after taking out the canister lift can using the lifting apparatus, the canister lid transport apparatus also moves to the docking hole and the canister, whose cover has been cut, is taken out through the docking hole by using a pickup means in the bottom of the docking hole. Then, the canister lid transport apparatus moves to the canister cutting station again.

Accordingly, the present invention enables to safely transfer the canister to which spent nuclear fuel is enclosed; to smoothly and easily lift and take out the canister to the cutting work space; to prevent radiation materials from being released outside the cutting work space while cutting the canister lid; and to prevent the cover of the handling cask from being exposed to radiation materials, thereby quickly and safely perform all working operations in order for superior work efficiency and high safety.

Further, upon lifting and taking out the canister lift can, it may obtain high safety by lifting and taking out the canister lift can with more stable conditions.

Further, there may be chips generated while cutting the canister lid to prevent from falling into the storage space, thereby establishing high reliability of cutting operation.

Further, the cut canister lid may be safely and smoothly transported, thereby enhancing work efficiency.

1. A spent nuclear fuel canister lid cutting system in dry environment, comprising: a transfer trolley for transferring a canister lift can for comprising a canister with sealed spent nuclear fuel, and a lid is covered with the inserted canister lift can;
a cutting facility wherein for cutting the lid of the canister, a handling cask at one side of the bottom is moved by the transfer trolley; a docking hole is formed to be docked with the handling cask; and a cutting work space keeps leak tightness while maintaining negative pressure for preventing release of radioactive materials;
an opening-closing apparatus which enables to be sliding on a rail for storing the lid of the handling cask while opening and closing the docking hole at the bottom surface wherein the docking hole of the cutting work space is formed;
a lifting apparatus which enables to lift, transport and take out the canister lift can by going up and down by a transport crane, which is configured to move in every directions on the top of the cutting work space;
a canister cutting station which stores the canister lift can which is lifted and transported to one side of the docking hole, thereby cutting the canister lid; and
a canister lid transport apparatus which combines to the canister lid on one side of the cutting work space, thereby supporting the canister lid while cutting, and taking out after cutting.

2. The spent nuclear fuel canister lid cutting system in dry environment according to claim 1, wherein the transfer trolley is equipped with a rotation bed for rotating the canister lift can.

3. The spent nuclear fuel canister lid cutting system in dry environment according to claim 1, wherein the opening-closing apparatus comprises a shielding plate body for closing and opening the docking hole and storing the lid of the handling cask while being sliding on a rail by driving means, and an opening-closing lid for storing the lid of the handling cask, which is installed by driving means to prevent contamination against radioactive materials at one side of the shielding plate body.

4. The spent nuclear fuel canister lid cutting system in dry environment according to claim 3, wherein a plurality of support protrusions is formed for holding the cover of the disposal canister, installed to the bottom side of the shielding plate body.

5. The spent nuclear fuel canister lid cutting system in dry environment according to claim 1, wherein the lifting apparatus comprises a lifting body forming a plurality of lifting legs to which a rope of the transport crane is connected on the top; a lifting gripper connecting to a joining groove formed on the top of the lid of the handling cask while being shuttled by a driving means such as a geared motor, gear mesh, etc., in the center of the lifting body; and a plurality of locking hooks engaging with a plurality of locking grooves formed on the top of the canister lift can around the bottom side of the lifting body.

6. The spent nuclear fuel canister lid cutting system in dry environment according to claim 1, wherein the canister cutting station comprises a storage block forming a storage space wherein the canister lift can is stored to the bottom side of the cutting work space; each slide board half-divided to be shuttled right and left on a rail, formed on both sides of the top of the storage block, by driving means;
and a clamshell cutting apparatus having cutting devices on the top of each slide board.

7. The spent nuclear fuel canister lid cutting system in dry environment according to claim 6, wherein the bottom side of the storage space should comprise the rotation bed for rotating the canister lift can and each camera for checking whether or not to place the canister lift can on the top and bottom of the storage space.

8. The spent nuclear fuel canister lid cutting system in dry environment according to claim 1, wherein the canister lid transport apparatus comprises a transport bracket member for being sliding along a rail between the canister cutting station and the docking hole, formed on one side of cutting work space, by driving means; and a canister lid combination member for having each bolt that may connect to holes for each bolt in the canister lid part, while being lifted by a driving means on the end of the transport bracket member.

9. The spent nuclear fuel canister lid cutting system in dry environment according to claim 8, wherein each bolt installed to the canister lid combination member is rotated by a driving means inside the canister lid combination member.
